(19) United States
(12) Patent Application Publication
(10) Pub. No.: US 2013/0142925 A1
(43) Pub. Date: Jun. 6, 2013

(54) METHOD OF PRODUCING AN EXTRACT ENRICHED WITH TRIGONELLINE (TRIG) AND/OR CHLOROGENIC ACIDS (CQA), EXTRACT ENRICHED WITH TRIGONELLINE (TRIG) AND/OR CHLOROGENIC ACIDS (CQA) AND THE USE OF SAME

(71) Applicant: Plantextrakt GmbH & Co. KG, Vestenbergsgreuth (DE)

(72) Inventors: Bernd BONNLÄNDER, Schwaig (DE); Erwin KRIESEL, Langenzenn (DE); Harsha PERERA, Nurnberg (DE)

(73) Assignee: PLANTEXTRAKT GMBH & CO. KG, Vestenbergsgreuth (DE)

(21) Appl. No.: 13/705,616

(22) Filed: Dec. 5, 2012

(30) Foreign Application Priority Data
Dec. 5, 2011 (EP) 11 191 897.5

(51) Int. Cl. A23L 1/28

(52) U.S. Cl. CPC A23L 1/28
USPC 426/250; 426/432; 426/435; 426/384; 426/655

(57) ABSTRACT

A method of producing an extract enriched with trigonelline (TRIG) and/or chlorogenic acids (CQA) from a TRIG and/or CQA containing organic plant material like Rubiacea plants, mate plants or the like, the method comprises the steps of:
providing an amount of the TRIG and/or CQA containing organic plant material in a container,
treating said amount of TRIG and/or CQA containing organic plant material with steam for a defined vaporisation period,
exposing the TRIG and/or CQA containing organic plant material steamed in the above step to hot water for least two times for extraction, and
removing said extract enriched with trigonelline (TRIG) and/or chlorogenic acid (CQA) from the residue.

### CROSS-REFERENCES TO RELATED APPLICATIONS

This application claims the priority of European Patent Application, Serial No. 11 191 897.5, filed Dec. 5, 2011, pursuant to 35 U.S.C. 119(a)-(d), the content of which is incorporated herein by reference in its entirety as if fully set forth herein.

### FIELD OF THE INVENTION

The invention refers to a method of producing an extract enriched with trigonelline (TRIG) and/or chlorogenic acids (CQA), further to such an extract and finally to the use of same.

The field of the invention refers to functional plant extracts of special species like raw coffee and mate. In this connection attention is to be drawn to the fact that coffee is known as a major source of antioxidants. Its positive effects on health are largely documented in actual scientific literature. In raw coffee chlorogenic acids (CQA) are known as most abundant polyphenols which are partly destroyed during roasting. Nevertheless coffee as beverage is one of the main contributors to the intake of antioxidants and due to the remaining chlorogenic acids. Hereunder a family of esters formed between trans-cinnamic acid (caffeoylquinic acid) and quinic acid are classically summarized:
CQA (caffeoylquinic acids)
pCoCQA (p-coumaroylcaffeoylquinic acids)
FQA (feruloylquinic acids)
diCQA (dicaffeoylquinic acids) and
CFQA (caffeoylferuloylquinic acid)

In broader range all structurally similar compounds as listed in the following formula overview occur in nature.

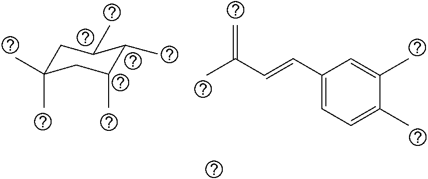

| | [symbol] | [symbol] |
|---|---|---|
| [symbol] | H | OH |
| [symbol] | OH | OH |
| [symbol] | OMe | OH |
| [symbol] | OMe | OMe |

[symbol]

indicates data missing or illegible when filed

Another compound especially present in coffee is trigonelline, an alkaloid which is correlated to other positive health effects of coffee, especially after it has been trans-formed during the roasting process.

### BACKGROUND OF THE INVENTION

The currently known prior art can roughly be outlined as follows:

In literature, e.g. in the so-called Farah overview, which is Viviane Marques, Adriana Farah, “Chlorogenic acids and related compounds in medicinal plants and infusions” in Food Chemistry 113 (2009), pages 1370-1376, different plant materials were evaluated for the content of CQAs, the so called secondary plant metabolites. Products are on the market containing up to 45% of this CQAs enriched by solvent extraction either from Europe or India.

The health benefits described are slimming or antioxidant properties. The slimming effect is attributed to a reduced utilization of carbohydrates by enzyme inactivation (amylases).

The trigonelline in coffee is the precursor of NMP (n-methylium pyridine) which is currently reported as a diabetes active principle in WO 2010/055170 A1.

WO 2010/054818 A1 discloses a method of preparation a NMP-containing extract starting with roasting trigonelline containing plant material (as e.g. coffee,). The roasted trigonelline-containing organic material is then treated with water to obtain an aqueous extract. The latter is then treated with polyamide and subjected to cation exchange chromatography to obtain a NMP-containing extract. Due to the use of polyamide this production method is not exclusively natural.

Trigonelline is further known in cosmetic applications, as disclosed in DE 3915535 A1.

From FR 2 734 479 A1 a process is known for the preparation of a green coffee extract in which the raw plant material is subjected to organic solvents like ethanol, from which traces may remain in the product, what is undesired for offering residue-free, certified (organic) products. Further on in the described process the decaffeinated raw coffee material is ground. This shows considerable disadvantages compared to processes in which the whole green coffee bean is extracted. Technical problems are e.g. the separation solid-liquid and enrichment, namely the distribution of CGA in the coffee bean.

### SUMMARY OF THE INVENTION

Starting from the prior art problems it is an object of the invention to present a method of producing an extract enriched with trigonelline (TRIG) and/or chlorogenic acids (CQA) in an all natural way, only by using water and steam.

This object is achieved by a method of producing an extract according to the invention including following method steps:
(a) providing an amount of the TRIG and/or CQA containing organic plant material, like Rubiacea plants, mate plants or the like, in a container,
(b) treating said amount of TRIG and/or CQA containing organic plant material with steam for a defined vaporisation period,
(c) exposing the TRIG and/or CQA containing organic plant material steamed in step (b) to hot water for least two times for extraction, and
(d) removing said extract, in each time gained in step (c), enriched with trigonelline (TRIG) and/or chlorogenic acid (CQA) from the residue.

The method according to the invention thus offers the possibility to supply such an extract as organic certified material, when starting from such raw plant material. The present inventor has surprisingly found out, that merely by a fractionated extraction by hot water after steam treatment, it is possible to obtain a trigonelline and CQA rich extract of different plant materials like coffee beans, mate and other Rubiaceae plant material or combinations thereof.

Preferred starting material as the TRIG and/or CQA containing organic plant material are coffee beans, in particular green beans of Coffea arabica and/or Coffea canephora, and/or mate leaves.

According to another preferred embodiment of the invention the organic plant material used in step (a) is heated, in particular at least slightly roasted before subjecting it to step (b) to get a product of a mild malty or pleasant taste, without reducing significantly the CQA content or producing NMP as in WO 2010/054818 A1.

A preferred range for the roasting temperature and time is 125° C. to 175° C., preferably 150° C., for a time period of 4 min to 6 min, preferably 5 min.

The vaporisation in step (b) may be performed by saturated, preferably dry steam for at least 3 min to 15 min, more preferably 5 min to 12 min, most preferably 10 min, wherein the steam pressure may be 4 bar to 6 bar, preferably 5 bar.

According to another preferred embodiment of the invention the temperature of the hot water used in step(s) (c) is 75° C. to 95° C., preferably 80° C. to 90° C., wherein the TRIG and/or CQA containing organic plant material may further be exposed to the hot water for a time period of 1 min to 20 min, preferably 10 min.

The process of maceration, i.e. subjecting the plant material to the hot water with an according extraction of the interesting substances TRIG and/or CQA and the subsequent removal of the extract maybe repeated successively for up to 15 times, preferably 5 to 10 times depending on the yield of extraction.

According to a further preferred embodiment of the invention the TRIG and/or CQA containing organic plant material before used in step (a) is subjected to a liquid carbon dioxide extraction, preferably to a supercritical carbon dioxide extraction. By this step a product with very low caffeine content can be obtained.

Further on it is possible that the extract obtained in step(s) (d) is concentrated, preferably by RO (reverse osmosis), thin film evaporation or any other gentle concentration technique to obtain a highly viscose, concentrated product. Thus the product can easily be pasteurized before being filled in adequate containers like plastic bags.

Another preferred alternative for the processing of the extract as to reasonable marketing conditions is spray or freeze drying the aqueous extract to a powdered extract product.

The invention further refers to an extract enriched with trigonelline (TRIG) and/or chlorogenic acids (CQA), produced by the above outlined method. Such an extract may be used for direct enrichment of all natural products with natural antioxidants and/or as completely natural source of trigonelline and/or for naturally colouring food products. The extract can give a pleasant, all natural green colour to any food product.

Summing up the extract according to the invention can be used as a food, to fortify other food products or as supplement as it is. Further on it can be used as source of high trigonelline content for use as it is or to produce NMP if applied to coffee before roasting. Opposed to US 2010/0112098 A1 where the application for weight reduction is described, this invention is directed to a process for producing an all natural extract, showing coloring properties and an enhanced content of CQA/TRIG as functional active ingredients

### DESCRIPTION OF THE PREFERRED EMBODIMENTS

The invention will now be explained more detailed based on following:

### EXAMPLES

### 1. Basic Process Technique

Raw green coffee beans or green mate leaves (or any other suitable plant from the Rubiaceae family) are steam treated to open the cellular structure of the leave or seed material. This is referable done with saturated steam of 2 bar for 10 min in an extraction vessel—step (a).

In a second step hot water preferably of 90° C. is added to this swollen material until covered. After a time of 1-20 minutes, preferably 10 min the extract is removed and the plant material is again covered with hot water of 85° C. The maceration and extraction is repeated 5 times to reach a total extraction yield of 12%—steps (b).

After each extraction step (b) the extract enriched with trigonelline (TRIG) and/or chlorogenic acid (CQA) is removed from the residue by filtering or centrifugation—step (c).

The first fraction containing higher amounts of CQA and TRIG is kept apart and a ratio of these two physiologically active substances can be blended by mixing different fractions in different ratios.

The following table 1 shows the content of 5-CQA, total CQA and TRIG against fractions of coffee bean extraction. It is an expression of the natural variability (concerning ingredients and structures) which has influence on the extraction process and the contents in the extract.

TABLE 1

| | SUM OF CQA/FQA/COQA = | | | SUM OF |
|---|---|---|---|---|
| FRACTION | TCQA [DRY MATTER] | | 5-CQA | TRIG |
| NO | Coffee 1 | Coffee 2 | [dm] | [dm] |
| 1 | 45% | 24% | 10% | 4.7% |
| 2 | 54% | 35% | 13% | 4.8% |
| 3 | 55% | 37% | 14% | 4.5% |
| 4 | 63% | 46% | 19% | 4.0% |
| 5 | 62% | 45% | 19% | 3.5% |

Additionally to the above-mentioned process steps the coffee beans are decaffeinated by supercritical or liquid CO₂ before said process, which is sufficiently known to the skilled persons and does not need any further explanation here.

Further on the beans or leaves may be shortly heated to 150° C. for 5 minutes before said process, which light roasting does not significantly impair the profile of the product. Otherwise TRIG/CQA may even be destroyed during the full roasting, see Clarke, R. J., Vitzthum, O. G. (Ed.), “Coffee-Recent Developments”, Blackwell Science, 2001.

### 2. Extraction of Arabica Coffee Beans

1 kg of graded and sieved Coffea arabica beans of Brasil origin (unwashed) were filled into a glass extraction cylinder and treated with saturated but dry steam for 5 minutes.

The swollen beans were extracted by 5 l of demineralized water of 90° C. two times gaining a yield of 20% extracted matter with a tCQA content of 15%, ⅓ of which was CQA.

### 3. Extraction of Decaffeinated Robusta Beans

3 t Coffea canephora (Pierre ex Froehn) beans from Uganda were decaffeinated by a process of CO₂. 2.6 kg of these bean were treated by saturated steam in an extraction cylinder and consecutively extracted by portions of 2,6 l water of 90° C. for 10 times. A total of 45% CQAs could be reached with a ratio of 6 or 5:1 (3-CQA/5-CQA or 4-CQA/5CQA)

### 4. Extraction of Mate Leaves

0.5 kg of green mate leaves were extracted by 1 l of water with temperature of 85° C. for 5 minutes after dry saturated steam treatment of 1 minute with 0.5 bar. The extraction was repeated 5 times and the fractions were analyzed for tCQA. The result (percent by weight related to dry matter) is presented in the following table 2.

TABLE 2

| FRACTION | TCQA [% DM] | 5-CQA [% DM] |
|---|---|---|
| 1 | 26 | 8 |
| 2 | 28 | 8 |
| 3 | 32 | 9 |
| 4 | 26 | 7 |
| 5 | 32 | 8 |
| 6 | 31 | 7 |

### 5. Control Extraction of Trigonella

1 kg of Trigonella foenum-graecum L. seeds were extracted but showed max content of 2% of trigonelline. From the plant Trigonella Foenum-graecum L. trigonelline was isolated for the first time—the name trigonelline has its origin from this plant. But the trigonelline contents from this plant are too little for an economic extraction.

What is claimed is:

1. A method of producing an extract enriched with at least one of trigonelline (TRIG) and chlorogenic acids (CQA) from at least one of a TRIG and CQA containing organic plant material like one of the group of Rubiacea plants, camellia, fabacea, astaracea, mate plants and the like, the method comprising the steps of:
(a) providing an amount of at least one of the TRIG and CQA containing organic plant material in a container,
(b) treating said amount of at least one of TRIG and CQA containing organic plant material with steam for a defined vaporisation period,
(c) exposing at least one of the TRIG and CQA containing organic plant material steamed in step (b) to hot water for at least two times for extraction, and
(d) removing said extract, in each time gained in step (c), enriched with at least one of trigonelline (TRIG) and chlorogenic acid (CQA) from the residue.

2. A method according to claim 1, wherein as at least one of the TRIG and CQA containing organic plant material at least one organic plant material selected of the group of coffee beans, beans of Coffea arabica, beans of Coffea canephoris, and mate leaves is used.

3. A method according to claim 1, wherein the organic plant material used in step (a) is slightly roasted before subjecting it to step (b).

4. A method according to claim 3, wherein the organic plant material used in step (a) is roasted by heating up to 125° C. to 175° C. for a time period of 4 min to 6 min.

5. A method according to claim 4, wherein the organic plant material used in step (a) is roasted by heating up to 150° C. for a time period of 5 min.

6. A method according to claim 1, wherein the vaporisation in step (b) is performed by saturated steam for at least 3 min to 15 min.

7. A method according to claim 6, wherein the vaporisation in step (b) is performed by dry steam for at least 5 min to 12 min.

8. A method according to claim 6, wherein the steam pressure in step (b) is 4 bar to 6 bar.

9. A method of claim 6, wherein the vaporisation in step (b) is performed in an extraction vessel.

10. A method according to claim 1, wherein the temperature of the hot water used in step(s) (c) is 75° C. to 95° C.

11. A method according to claim 10, wherein at least one of the TRIG and CQA containing organic plant material is exposed to the hot water for a time period of 1 min to 20 min.

12. A method according to claim 10, wherein at least one of the TRIG and CQA containing organic plant material is exposed to the hot water for a time period of 10 min.

13. A method according to claim 10, wherein the step (c) in combination with step (d) is repeated successively for up to 5 to 15 times.

14. A method according to claim 1, wherein at least one of the TRIG and CQA containing organic plant material before used in step (a) is subjected to a liquid carbon dioxide extraction.

15. A method according to claim 1, wherein at least one of the TRIG and CQA containing organic plant material before used in step (a) is subjected to a supercritical carbon dioxide extraction.

16. A method according to claim 1, wherein the extract obtained in step(s) (d) is concentrated to obtain a highly viscose, concentrated product.

17. A method according to claim 16, wherein the extract obtained in step(s) (d) is concentrated by one of the group of reverse osmosis and thin film evaporation to obtain a highly viscose, concentrated product.

18. A method according to claim 1, wherein one of the group of the extract obtained in step(s) (d) and the highly viscose, concentrated product is subjected to one of the group of spray and freeze drying to obtain a powdered extract product.

19. An extract enriched with at least one of trigonelline (TRIG) and chlorogenic acids (CQA), produced by the method of producing an extract enriched with at least one of trigonelline (TRIG) and chlorogenic acids (CQA) from at least one of a TRIG and CQA containing organic plant material like one of the group of Rubiacea plants, camellia, fabacea, astaracea, mate plants and the like, the method comprising the steps of:
(a) providing an amount of at least one of the TRIG and CQA containing organic plant material in a container,
(b) treating said amount of at least one of TRIG and CQA containing organic plant material with steam for a defined vaporisation period,
(c) exposing at least one of the TRIG and CQA containing organic plant material steamed in step (b) to hot water for at least two times for extraction, and
(d) removing said extract, in each time gained in step (c), enriched with at least one of trigonelline (TRIG) and chlorogenic acid (CQA) from the residue.

20. A use of an extract enriched with at least one of trigonelline (TRIG) and chlorogenic acids (CQA), produced by the method of producing an extract enriched with at least one of trigonelline (TRIG) and chlorogenic acids (CQA) from at least one of a TRIG and CQA containing organic plant material like one of the group of Rubiacea plants, camellia, fabacea, astaracea, mate plants and the like, the method comprising the steps of:
(a) providing an amount of at least one of the TRIG and CQA containing organic plant material in a container,
(b) treating said amount of at least one of TRIG and CQA containing organic plant material with steam for a defined vaporisation period,
(c) exposing at least one of the TRIG and CQA containing organic plant material steamed in step (b) to hot water for at least two times for extraction, and
(d) removing said extract, in each time gained in step (c), enriched with at least one of trigonelline (TRIG) and chlorogenic acid (CQA) from the residue
at least one of for a direct enrichment of all natural products with natural antioxidants, and
as completely natural source of trigonelline, and
naturally coloring food products.
